(19) United States
(12) Patent Application Publication
(10) Pub. No.: US 2012/0300100 A1
(43) Pub. Date: Nov. 29, 2012

(54) NOISE REDUCTION PROCESSING APPARATUS, IMAGING APPARATUS, AND NOISE REDUCTION PROCESSING PROGRAM

(75) Inventors: Mitsuhiro OKAZAKI, Saitama-shi (JP); Takao TAKIZAWA, Yokohama-shi (JP)

(73) Assignee: NIKON CORPORATION, Tokyo (JP)

(21) Appl. No.: 13/475,493

(22) Filed: May 18, 2012

(30) Foreign Application Priority Data
May 27, 2011 (JP) 2011-119758

(51) Int. Cl. H04N 5/225; H04B 15/00

(52) U.S. Cl. 348/231.4; 381/94.3; 348/E05.024

(57) ABSTRACT

A noise reduction processing apparatus includes a timing signal detection unit that detects an operation timing signal indicating a timing when an operation unit is operated, an audio signal acquisition unit that acquires an audio signal, and on the basis of the operation timing signal, a noise reduction processing unit that calculates first frequency spectra of an audio signal acquired during a time period which has high possibility that noise caused by an operation of the operation unit is generated and second frequency spectra of an audio signal acquired during a time period which has high possibility that the noise is not generated, and calculates a noise reduction audio signal obtained by performing noise reduction to the audio signal on the basis of frequency spectra in which at least a part of the calculated first frequency spectra are replaced with corresponding portions of the calculated second frequency spectra.

### CROSS-REFERENCE TO RELATED APPLICATION

Priority is claimed on Japanese Patent Application No. 2011-119758, filed on May 27, 2011, the contents of which are incorporated herein by reference.

### BACKGROUND

1. Field of the Invention

The present invention relates to a noise reduction processing apparatus, an imaging apparatus, and a noise reduction processing program, which subtract noise from an audio signal.

2. Description of Related Art

For example, there is a technique in which, in order to remove ambient sounds which are continuously generated as noise, noise (a noise component included in an audio signal) corresponding to the ambient sounds is calculated from the audio signal, and this noise is subtracted from the audio signal (for example, Japanese Unexamined Patent Application Publication No. 2005-195955).

### SUMMARY

In an optical system provided in an imaging apparatus, when a rotation direction of a driving system such as a gear train driving lenses is reversed, there are cases where the volume of noise temporarily becomes larger. As such, in a case where a noise generated due to the driving depending on an operational state of an operation unit or a timing is different, there is a problem in that if a noise reduction process using the technique of Japanese Unexamined Patent Application Publication No. 2005-195955 is performed, the target sound which is to be collected deteriorates.

The aspects of the present invention provides a noise reduction processing apparatus, an imaging apparatus, and a noise reduction processing program, which reduce deterioration of a target sound.

According to the aspects of the present invention, there is provided a noise reduction processing apparatus including a timing signal detection unit that detects an operation timing signal indicating the timing when an operation unit is operated; an audio signal acquisition unit that acquires an audio signal; and on the basis of the operation timing signal, a noise reduction processing unit that calculates first frequency spectra of an audio signal acquired during a time period which has high possibility that noise caused by an operation of the operation unit is generated and second frequency spectra of an audio signal acquired during a time period which has high possibility that the noise is not generated, and calculates a noise reduction audio signal obtained by performing noise reduction to the audio signal on the basis of frequency spectra in which at least a part of the calculated first frequency spectra are replaced with corresponding portions of the calculated second frequency spectra.

According to the aspects of the present invention, it is possible to reduce deterioration of a target sound during in a noise reduction process.

### BRIEF DESCRIPTION OF THE DRAWINGS

FIG. 1 is a block diagram illustrating an example of a configuration of an imaging apparatus including a noise reduction processing unit according to an embodiment of the present invention.

FIG. 2 is a reference diagram illustrating an example of a relationship between an operation timing signal of an operation unit according to the embodiment of the present invention and an audio signal.

FIG. 3 is a reference diagram illustrating a relationship between the audio signal shown in FIG. 2 and a window function.

FIG. 4 is a diagram illustrating an example of a first frequency spectrum and a second frequency spectrum which are acquired by an impulsive sound noise reduction processing unit according to the embodiment of the present invention.

FIG. 5 is a diagram illustrating an example of frequency components of each frequency spectrum shown in FIG. 3.

FIG. 6 is a diagram illustrating an example of the impulsive sound noise reduction process according to the present embodiment.

FIG. 7 is a flowchart illustrating an example of a noise reduction processing method according to the present embodiment.

FIG. 8A is a diagram illustrating an example of a frequency spectrum in a case where a target sound is a male voice.

FIG. 8B is a diagram illustrating an example of a frequency spectrum in a case where a target sound is a female voice.

FIG. 9 is a diagram illustrating an example of an encoder output and a microphone audio signal.

FIG. 10 is a diagram illustrating an example of a command output, the encoder output, and the microphone audio signal.

FIG. 11 is a reference diagram illustrating another example of the relationship between the operation timing signal of the operation unit according to the embodiment of the present invention and the audio signal.

FIG. 12 is a reference diagram illustrating a relationship between the audio signal shown in FIG. 11 and a window function.

FIG. 13 is a diagram illustrating another example of the first frequency spectrum and the second frequency spectrum which are acquired by the impulsive sound noise reduction processing unit according to the embodiment of the present invention.

### DESCRIPTION OF EMBODIMENTS

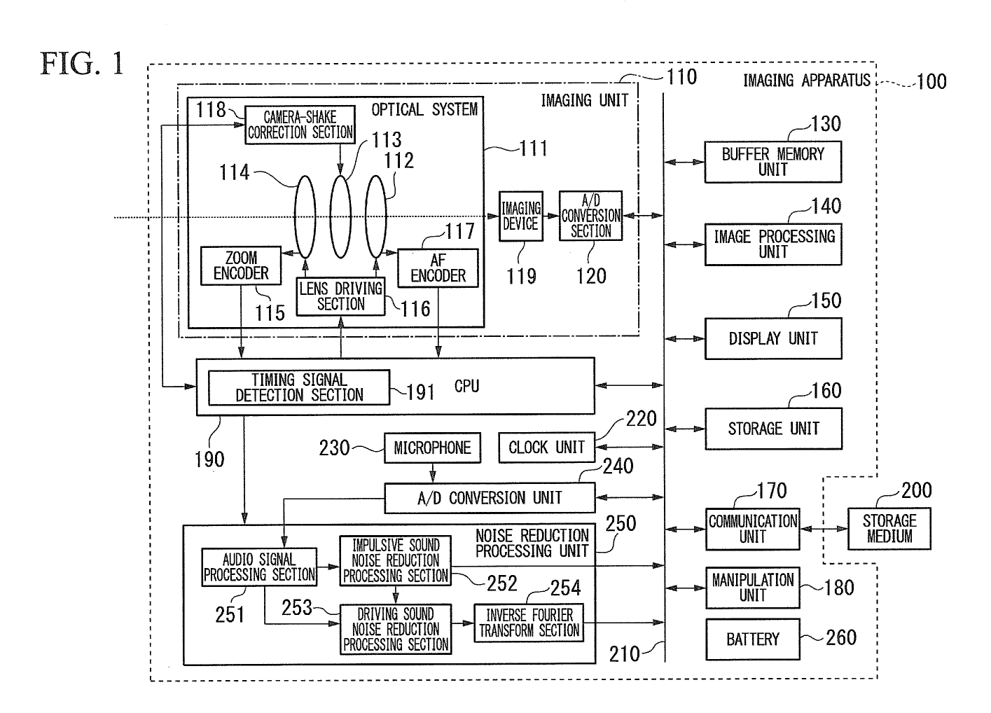

Embodiments of the present invention will be described in detail with reference to the drawings. FIG. 1 is a block diagram illustrating a configuration of an imaging apparatus according to the present embodiment.

As shown in FIG. 1, the imaging apparatus 100 captures an image using an optical system, stores obtained image data in a storage medium 200, performs a noise reduction process for a collected microphone audio signal, and stores an audio signal having undergone the noise reduction process in the storage medium 200.

The imaging apparatus 100 has a noise reduction processing unit 250. The noise reduction processing unit 250 performs a noise reduction process for reducing noise from a sound collected by a microphone.

The noise reduction processing unit 250 according to the present embodiment performs a noise reduction process for reducing noise (hereinafter, referred to as an operation sound) generated by an operation of an operation unit. For example, in the imaging apparatus 100, in a case where the optical system is driven in a process such as AF (Auto Focus) or VR (Vibration Reduction), noise (operation sound) is generated when a motor or the optical system is moved. In addition, when the motor changes a rotation direction, noise (operation sound) of a large sound is temporarily generated. As such, when an operational state of the operation unit is varied, the large sound which is temporarily generated is referred to as an impulsive sound. On the other hand, a sound which is smaller than the impulsive sound and is generated when the optical system or the motor is moved is referred to as a driving sound. In other words, the driving sound is noise other than the impulsive sound. The noise reduction processing unit 250 according to the present embodiment performs an impulsive sound noise reduction process for reducing noise due to an impulsive sound from the microphone audio signal and performs a driving sound noise reduction process for reducing noise due to a driving sound from the microphone audio signal.

Hereinafter, an example of the configuration of the imaging apparatus 100 and the noise reduction processing unit 250 will be described in detail. In addition, although in the present embodiment an example where the noise reduction processing unit 250 is embedded in the imaging apparatus 100 is described, the present invention is not limited thereto. For example, the noise reduction processing unit 250 may be an external device of the imaging apparatus 100.

The imaging apparatus 100 includes an imaging unit 110, a buffer memory unit 130, an image processing unit 140, a display unit 150, a storage unit 160, a communication unit 170, a manipulation unit 180, a CPU 190 (control unit), a clock unit 220, a microphone 230 (audio signal acquisition unit), an A/D conversion unit 240, a noise reduction processing unit 250, and a battery 260.

The imaging unit 110 includes an optical system 111, an imaging device 119, and an A/D (analogue/digital) conversion section 120, and is controlled by the CPU 190 according to a predefined driving pattern on the basis of set imaging conditions (for example, the aperture value, the exposure value, and the like). The imaging unit 110 forms an optical image via the optical system 111 on the imaging device 119, and generates image data based on the optical image which is converted into a digital signal by the A/D conversion section 120.

The optical system 111 includes a focusing lens (hereinafter, referred to as an “AF lens”) 112, a camera-shake correction lens (hereinafter, referred to as a “VR lens”) 113, a zoom lens 114, a zoom encoder 115 (operation detection unit), a lens driving section 116 (driving unit), an AF encoder 117 (operation detection unit), and a camera-shake correction section 118 (driving unit).

The respective constituent elements of the optical system 111 are driven according to the respective driving patterns in a focusing process, a camera-shake correction process, and a zoom process performed by the CPU 190. That is, the optical system 111 is an operation unit in the imaging apparatus 100.

In the optical system 111, an optical image is incident from the zoom lens 114, passes through the zoom lens 114, the VR lens 113, and the AF lens 112 in this order, and is guided to a light receiving surface of the imaging device 119.

The lens driving section 116 receives a driving control signal (command) for controlling positions of the AF lens 112 and the zoom lens 114 from the CPU 190. The lens driving section 116 controls positions of the AF lens 112 and the zoom lens 114 in response to the received driving control signal.

That is, the driving control signal is input to the lens driving section 116 from the CPU 190 so as to drive the lens driving section 116, and thereby the AF lens 112 and the zoom lens 114 are moved (operated). In the present embodiment, a timing when the CPU 190 outputs the driving control signal is referred to as an operation start timing when the AF lens 112 and the zoom lens 114 start to be operated.

The zoom encoder 115 detects a zoom position indicating a position of the zoom lens 114 so as to be output to the CPU 190. The zoom encoder 115 detects a movement of the zoom lens 114, and outputs a pulse signal to the CPU 190, for example, in a case where the zoom lens 114 is moved inside the optical system 111. On the other hand, in a case where it is stopped, the zoom encoder 115 stops outputting the pulse signal.

The AF encoder 117 detects a focus position indicating a position of the AF lens 112 so as to be output to the CPU 190. The AF encoder 117 detects a movement of the AF lens 112, and outputs a pulse signal to the CPU 190, for example, in a case where the AF lens 112 is moved inside the optical system 111. On the other hand, in a case where it is stopped, the AF encoder 117 stops outputting the pulse signal.

In addition, the zoom encoder 115 may detect a driving direction of the zoom lens 114 in order to detect a zoom position. In addition, the AF encoder 117 may detect a driving direction of the AF lens 112 in order to detect a focus position.

For example, the zoom lens 114 or the AF lens 112 is moved in the optical axis direction when driving mechanisms (for example, a motor, a cam, and the like) driven by the lens driving section 116 are rotated clockwise (CW) or counterclockwise (CCW). The zoom encoder 115 and the AF encoder 117 may detect each of the movements of the zoom lens 114 and the AF lens 112 by detecting rotation directions (here, clockwise or counterclockwise) of the driving mechanisms.

The camera-shake correction section 118 includes, for example, a vibration gyroscope mechanism, detects optical axis deviation of an image due to the optical system 111, and moves the VR lens 113 in a direction for removing the optical axis deviation. The camera-shake correction section 118 outputs a high level signal to the CPU 190, for example, in a state where the VR lens 113 is moved. On the other hand, in a state where the VR lens 113 is stopped, the camera-shake correction section 118 stops outputting a low level signal.

The imaging device 119 includes, for example, a photoelectric conversion surface, and converts the optical image formed on the light receiving surface into an electric signal which is output to the A/D conversion section 120.

The imaging device 119 stores image data, which is obtained when receiving a photographic instruction via the manipulation unit 180, in the storage medium 200 via the A/D conversion section 120 as a still image or a moving image. On the other hand, in a state of not receiving a photographic instruction via the manipulation unit 180, the imaging device 119 outputs image data which is continuously obtained to the CPU 190 and the display unit 150 via the A/D conversion section 120 as through image data.

The A/D conversion section 120 digitizes the electric signal which has undergone the conversion by the imaging device 119, and outputs image data which is a digital signal to the buffer memory unit 130.

The buffer memory unit 130 temporarily stores image data which is imaged by the imaging unit 110. In addition, the buffer memory unit 130 temporarily stores a microphone audio signal corresponding to a microphone detection sound collected by the microphone 230. Further, the buffer memory unit 130 may store a microphone audio signal corresponding to a microphone detection sound by correlating a time point when the microphone detection sound is collected with a position in the buffer memory unit 130.

The image processing unit 140 refers to image processing conditions stored in the storage unit 160 and performs an image process for the image data which is temporarily stored in the buffer memory unit 130. The image data having undergone the image process is stored in the storage medium 200 via the communication unit 170. In addition, the image processing unit 140 may perform the image process for image data stored in the storage medium 200.

The display unit 150 is, for example, a liquid crystal display, and displays image data obtained by the imaging unit 110 or an operating screen, and the like.

The storage unit 160 stores judgment condition which are referred to when the CPU 190 determines a scene, or imaging conditions correlated with each scene which is determined through the scene determination, and the like.

The communication unit 170 is connected to the storage medium 200 which is detachable and performs recording, reading or deletion of information (image data or audio data and the like) on or from the storage medium 200.

The manipulation unit 180 includes, for example, a power switch, a shutter button, multiple selectors (cross keys), or other operating keys, receives a manipulation input of a user when the user performs the manipulation, and outputs manipulation information corresponding to the manipulation input to the CPU 190. There are cases where the manipulation unit 180 generates a physical operation sound when pressed by the user. In the present embodiment, a timing when the manipulation information corresponding to the manipulation input of the user is input to the CPU 190 from the manipulation unit 180 is referred to as an operation start timing when an operation of the manipulation unit 180 is started.

The storage medium 200 is a storage unit which is attachable to and detachable from the imaging apparatus 100, and stores, for example, image data generated (photographed) by the imaging unit 110 or an audio signal for which an audio signal process has been performed by the noise reduction processing unit 250.

A bus 210 is connected to the imaging unit 110, the buffer memory unit 130, the image processing unit 140, the display unit 150, the storage unit 160, the communication unit 170, the manipulation unit 180, the CPU 190, the clock unit 220, the A/D conversion unit 240, and the noise reduction processing unit 250, and transmits data or the like which is output from the respective constituent elements.

The clock unit 220 keeps the date or the time, and outputs date information indicating the counted date.

The microphone 230 collects ambient sounds, and outputs a microphone audio signal of the sounds to the A/D conversion unit 240. Microphone detection sounds collected by the microphone 230 mainly include a target sound which is to be collected and an operation sound (noise) caused by the operation unit.

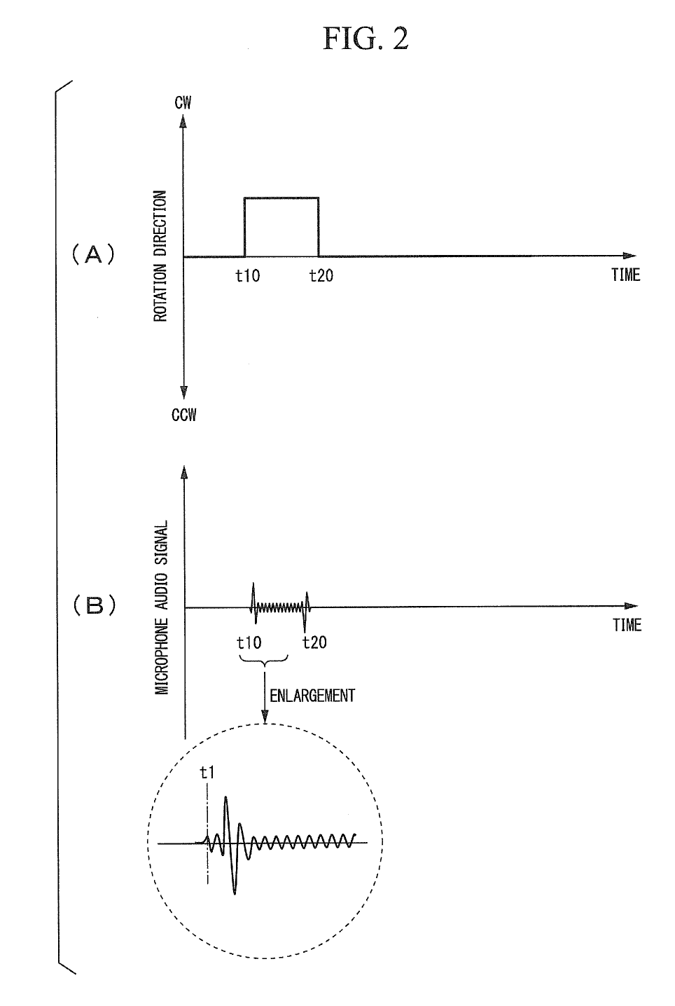

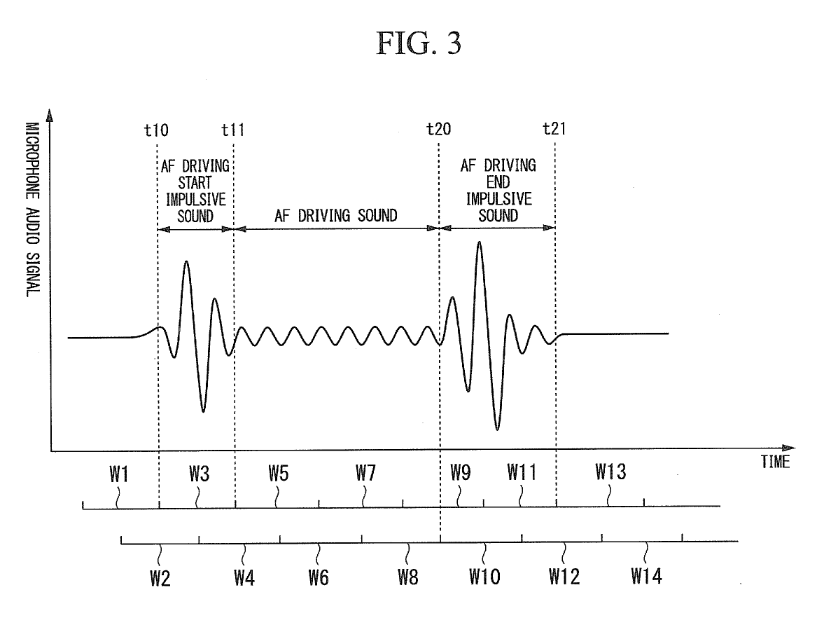

Here, with regard to a microphone audio signal acquired by the microphone 230, for example, a microphone audio signal obtained when the AF lens 112 is operated will be described with reference to, for example, FIGS. 2 and 3.

FIG. 2(A) shows an example of a relationship between an output of the AF encoder 117 and time. FIG. 2(B) shows an example of a relationship between a microphone audio signal and time. In addition, for convenience of description, FIG. 2(B) shows only an audio signal of the operation sound of the microphone audio signal and does not show an audio signal of the target sound. The driving pattern of the AF lens 112 shown in FIG. 2(A) and FIG. 2(B) indicates, for example, a driving pattern in a case where an AF process for adjusting focus at a focal length a is performed.

In FIG. 2(A), the longitudinal axis expresses a rotation direction of the driving mechanism driving the AF lens 112, which is obtained from an output of the AF encoder 117.

In the driving pattern where an AF process for adjusting focus at a focal length a is performed, as shown in FIG. 2(A), the driving mechanism driving the AF lens 112 is rotated clockwise CW during the time points t10 to t20 and is then stopped.

In other words, the time point t10 indicates an operation start timing of the AF lens 112, and the time point t20 indicates an operation stop timing of the AF lens 112. Further, in the present embodiment, the time point t10 of the operation start timing indicates a timing when the driving control signal for controlling a position of the AF lens 112 is output by the CPU 190. The time point t20 of the operation stop timing indicates a timing when an output of the pulse signal from the AF encoder 117 is stopped.

Therefore, as shown in FIG. 2(B), during the time period of the time points t10 to t20, an operation sound due to the AF lens 112 is superposed on the microphone audio signal or the operation sound may be superposed thereon with high possibility. In the present embodiment, a case where noise which is an operation sound due to the AF lens 112 is generated during the time period of the time points t10 to t20 will be described below.

In addition, as shown in FIG. 2(B), there is high possibility that impulsive sounds may be generated at the time points t10 and t20, respectively. In the present embodiment, a case where the impulsive sounds are generated by the AF lens 112 at the time points t10 and t20 will be described below.

In addition, in a case where an impulsive sound is generated, time when the impulsive sound is generated with high possibility is predefined according to each driving pattern. In the driving pattern where an AF process for adjusting focus at a focal length α is performed, the time when the impulsive sound is generated as shown in FIG. 3 is defined.

FIG. 3 shows an example of the microphone audio signal collected by the microphone 230 when the AF lens 112 is driven by the driving pattern where an AF process for adjusting focus at a focal length α is performed. In the graph shown in FIG. 3, the longitudinal axis expresses a microphone audio signal collected by the microphone 230 and the transverse axis expresses time. In addition, for convenience of description, FIG. 3 shows only an audio signal of the operation sound of the microphone audio signal and does not show an audio signal of the target sound.

In the driving pattern where an AF process for adjusting focus at a focal length a is performed, the time of the time points t10 to t11 and the time of the time points t20 to t21 are respectively predefined as the time when the impulsive sound is generated.

In the present embodiment, as shown in FIG. 3, an example where the impulsive sound is generated during the time periods when the impulsive sound is generated will be described.

Referring to FIG. 1 again, the description of each constituent element of the imaging apparatus 100 is continued.

The CPU 190 controls the imaging unit 110 according to a driving pattern corresponding to set imaging conditions (for example, an aperture value, an exposure value, and the like). The CPU 190 generates a driving control signal for driving the lens driving section 116 on the basis of a zoom position output from the zoom encoder 115 and a focus position output from the AF encoder 117, and outputs the driving control signal to the lens driving section 116. A generation algorithm thereof may appropriately use the existing algorithm as necessary.

A timing signal detection section 191 detects timings when an operational state of the operation unit included in the imaging apparatus 100 is varied. The timings when an operational state is varied include, for example, an operation-start-timing when an operation of the operation unit is started and an operation-stop-timing when an operation of the operation unit is stopped.

The operation unit which is described here is, for example, the above-described optical system 111 or manipulation unit 180, and is a constituent element which generates an operation sound (or, may possibly generate an operation sound) by operating or being operated among the constituent elements included in the imaging apparatus 100.

In other words, the operation unit is a constituent element where an operation sound occurring by the operation unit operating or an operation sound occurring by the operation unit being operated is collected (or, may possibly be collected) by the microphone 230 among the constituent elements included in the imaging apparatus 100.

For example, the timing signal detection section 191 may detect timings when an operational state of the operation unit is varied on the basis of the driving control signal for operating the operation unit. The driving control signal is a driving control signal for causing a driving unit driving the operation unit to operate the operation unit, or a driving control signal for driving the driving unit.

For example, the timing signal detection section 191 detects an operation-start-timing when an operation of the zoom lens 114, the VR lens 113 or the AF lens 112 is started on the basis of the driving control signal input to the lens driving section 116 or the camera-shake correction section 118 in order to drive the zoom lens 114, the VR lens 113, or the AF lens 112. In this case, the timing signal detection section 191 may detect the operation-start-timing on the basis of a process or a command which is executed inside the CPU 190 in a case where the CPU 190 generates the driving control signal.

In addition, the timing signal detection section 191 may detect the operation-start-timing on the basis of an operating signal which is input from the manipulation unit 180 and indicates driving of the zoom lens 114 or the AF lens 112.

In addition, the timing signal detection section 191 may detect timings when an operational state of the operation unit is varied on the basis of a signal indicating that the operation unit is operated.

For example, the timing signal detection section 191 may detect the operation-start-timing of the zoom lens 114 or the AF lens 112 by detecting that the zoom lens 114 or the AF lens 112 is driven on the basis of an output of the zoom encoder 115 or the AF encoder 117. Further, the timing signal detection section 191 may detect the operation-stop-timing of the zoom lens 114 or the AF lens 112 by detecting that the zoom lens 114 or the AF lens 112 is stopped on the basis of an output of the zoom encoder 115 or the AF encoder 117.

In addition, the timing signal detection section 191 may detect an operation-start-timing of the VR lens 113 by detecting that the VR lens 113 is driven on the basis of an output from the camera-shake correction section 118. The timing signal detection section 191 may detect an operation-stop-timing of the VR lens 113 by detecting that the VR lens 113 is stopped on the basis of an output from the camera-shake correction section 118.

Moreover, the timing signal detection section 191 may detect the timing of when the operation unit is operated by detecting that the manipulation unit 180 is manipulated on the basis of an input from the manipulation unit 180.

The timing signal detection section 191 detects an operation-start-timing of the operation unit included in the imaging apparatus 100, and outputs an operation-start-timing signal (operation detection signal) indicating the detected operation-start-timing to the noise reduction processing unit 250. In addition, the timing signal detection section 191 detects an operation-stop-timing and outputs an operation-stop-timing signal (operation detection signal) indicating the detected operation-stop-timing to the noise reduction processing unit 250.

In the present embodiment, the timing signal detection section 191 determines a timing when the driving control signal for moving the AF lens 112 is output to the lens driving section 116 from the CPU 190, as the operation-start-timing of the AF lens 112. For example, the timing signal detection section 191 outputs information indicating the time points t10 to t11 when the impulsive sound shown in the example using FIG. 3 is generated as an operation-start-timing signal.

In addition, on the basis of a pulse signal output from the AF encoder 117, the timing signal detection section 191 determines time when the output of the pulse signal is stopped as the operation-stop-timing when an operation of the AF lens 112 is stopped. For example, the timing signal detection section 191 outputs information indicating the time points t20 to t21 when the impulsive sound shown in the example using FIG. 3 is generated as an operation-stop-timing signal.

The A/D conversion unit 240 converts the microphone audio signal which is an analog signal input from the microphone 230 into the microphone audio signal which is a digital signal. The A/D conversion unit 240 outputs the microphone audio signal which is a digital signal to the noise reduction processing unit 250.

In addition, the A/D conversion unit 240 may have a configuration that stores the microphone audio signal which is a digital signal in the buffer memory unit 130 or the storage medium 200.

The noise reduction processing unit 250 performs a noise reduction process for reducing noise which is an operation sound caused by the operation unit such as, for example, the AF lens 112, the VR lens 113, or the zoom lens 114, for the microphone audio signal converted into the digital signal by the A/D conversion unit 240, and stores the audio signal which has undergone the noise reduction process in the storage medium 200.

The noise reduction processing unit 250 includes an audio signal processing section 251, an impulsive sound noise reduction processing section 252, a driving sound noise reduction processing section 253, and an inverse Fourier transform section 254.

The audio signal processing section 251 weights the microphone audio signal output from the A/D conversion unit 240 with a window function for each section which is defined in advance, converts the microphone audio signal for each section into a spectrum represented in a frequency domain, and outputs the spectrum represented in the frequency domain to the impulsive sound noise reduction processing section 252 and the driving sound noise reduction processing section 253.

The audio signal processing section 251 performs, for example, the Fourier transform or the fast Fourier transform (FFT) for the microphone audio signal so as to convert the microphone audio signal into one in the frequency domain. The audio signal processing section 251 performs, for example, the Fourier transform for the microphone audio signal, thereby calculating a frequency spectrum corresponding to each section of the window function.

Here, the predefined section in the window function is a unit (frame) of the signal process, and is a section which is repeated at a constant interval. Each section of the window function overlaps half of each section of another window function. In addition, the window function may use, for example, the Hanning window function.

With reference to FIG. 3 described above, an example of the frequency spectrum corresponding to each section of the window functions calculated by the audio signal processing section 251 will be described.

As described above, the audio signal processing section 251 weights the microphone audio signal output from the A/D conversion unit 240 with the window functions W1 to W14 which overlap half of other sections as shown in FIG. 3. Thereby, the microphone audio signal is divided into the sizes of the window functions. The audio signal processing section 251 performs, for example, a Fourier transform for the microphone audio signal of each section weighted with the window functions W1 to W14, and calculates frequency spectra S1 to S14 in the frequency domain. In other words, the frequency spectra S1 to S14 calculated by the audio signal processing section 251 are frequency spectra corresponding to the sections of the window functions W1 to W14.

As shown in FIG. 3, the section of the time points t10 to t11, and the section of the time points t20 to t21 are sections where an impulsive sound is generated. In addition, the section of the time points t11 to t20 is a section where a driving sound is generated.

In the present embodiment, the frequency spectra S2 to S4 corresponding to the window functions W2 to W4 are audio information including the impulsive sound generation period t10 to t11 corresponding to the operation-start-timing t10 of the AF lens 112. In addition, the frequency spectra S9 to S12 corresponding to the window functions W9 to W12 are audio information including the impulsive sound generation period t20 to t21 corresponding to the operation-stop-timing t20 of the AF lens 112. The frequency spectra S5 to S8 corresponding to the window functions W5 to W8 are audio information corresponding to the driving sound generation period by the AF lens 112.

The audio signal processing section 251 calculates, for example, the frequency spectra S1 to S14, and compares a sum total of frequency components of the frequency spectra corresponding to the impulsive sound generation periods with a predefined threshold value. The predefined threshold value is a sum total of frequency components of a frequency spectrum of a target sound where sound deterioration caused by an impulsive sound is small because the target sound is larger than the impulsive sound.

If it is determined that the sum total of the frequency components of the frequency spectra corresponding to the impulsive sound generation periods is smaller than the predefined threshold value, the driving sound noise reduction processing section 253 outputs the calculated frequency spectra S1 to S14 to the impulsive sound noise reduction processing section 252 and performs a control so as to perform an impulsive sound reduction process.

On the other hand, if it is determined that the sum total of the frequency components of the frequency spectra corresponding to the impulsive sound generation periods is equal to or more than the predefined threshold value, the driving sound noise reduction processing section 253 outputs the calculated frequency spectra S1 to S14 to the driving sound noise reduction processing section 253 and performs a control so as to perform a driving sound reduction process.

The impulsive sound noise reduction processing section 252 acquires a frequency spectrum (hereinafter, referred to as a first frequency spectrum) corresponding to a time period having high possibility that an impulsive sound may be generated, for example, from the frequency spectra S1 to S14 output from the audio signal processing section 251 on the basis of the operation timing signal (operation detection signal) input from the timing signal detection section 191. For example, the impulsive sound noise reduction processing section 252 acquires the frequency spectra S2 to S4 corresponding to the time period when the impulsive sound may possibly be generated on the basis of the operation timing signal indicating the impulsive sound generation period t10 to t11 corresponding to the operation-start-timing t10, as the first frequency spectra. The impulsive sound noise reduction processing section 252 acquires the frequency spectra S9 to S12 corresponding to the time period when the impulsive sound may possibly be generated on the basis of the operation timing signal indicating the impulsive sound generation period t20 to t21 corresponding to the operation-stop-timing t20, as the first frequency spectra.

In addition, the impulsive sound noise reduction processing section 252 acquires a frequency spectrum (hereinafter, referred to as a second frequency spectrum) corresponding to a time period having high possibility that the impulsive sound may not be generated from the frequency spectra S1 to S14 output from the audio signal processing section 251 on the basis of the operation timing signal input from the timing signal detection section 191. The impulsive sound noise reduction processing section 252 acquires the second frequency spectrum having low possibility of including the impulsive sound for each of the first frequency spectra having high possibility of including the impulsive sound. In the present embodiment, the impulsive sound noise reduction processing section 252 acquires a frequency spectrum closest to the first frequency spectra in the time axis direction, as the second frequency spectra. In other words, the impulsive sound noise reduction processing section 252 acquires frequency spectra adjacent to or overlapping the first frequency spectra in the time axis direction, as the second frequency spectra.

Further, in the present embodiment, the second frequency spectra are frequency spectra corresponding to a time period having high possibility that the impulsive sound may not be generated. However, the present invention is not limited thereto, and the second frequency spectra are preferably frequency spectra corresponding to a time period having high possibility that a noise sound generated by the operation of the operation unit may not be generated. In addition, the second frequency spectra may be frequency spectra corresponding to a time period having a high possibility that the operation sound may not be generated.

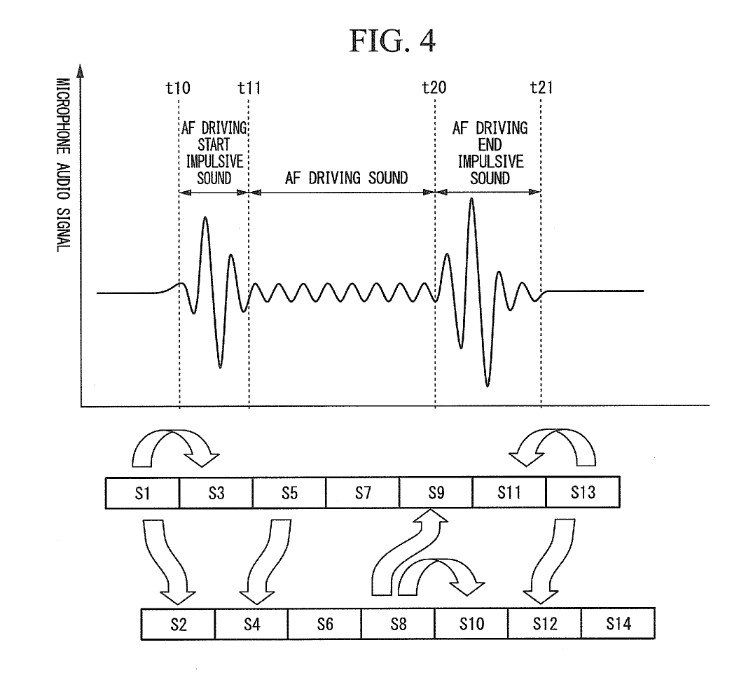

Here, with reference to FIG. 4, a description will be made of an example of the relationship between the first frequency spectra and the second frequency spectra acquired by the impulsive sound noise reduction processing section 252. FIG. 4 is a diagram illustrating an example of the relationship between the first frequency spectra and the second frequency spectra acquired by the impulsive sound noise reduction processing section 252.

For example, the impulsive sound noise reduction processing section 252 acquires the frequency spectrum S1 which is closest to the frequency spectra S2 and S3 in the past direction on the time axis, as the second frequency spectrum corresponding to the frequency spectra S2 and S3 which are the first frequency spectra on the basis of the operation timing signal indicating the impulsive sound generation period t10 to t11 corresponding to the operation-start-timing t10. In addition, the impulsive sound noise reduction processing section 252 acquires the frequency spectrum S5 which is closest to the frequency spectrum S4 in the future direction on the time axis, as the second frequency spectrum corresponding to the frequency spectrum S4 which is the first frequency spectrum on the basis of the operation timing signal indicating the impulsive sound generation period t10 to t11 corresponding to the operation-start-timing t10.

Further, the impulsive sound noise reduction processing section 252 acquires the frequency spectrum S8 which is closest to the frequency spectra S9 and S10 in the past direction on the time axis, as the second frequency spectrum corresponding to the frequency spectra S9 and S10 which are the first frequency spectra on the basis of the operation timing signal indicating the impulsive sound generation period t20 to t21 corresponding to the operation-stop-timing t20. In addition, the impulsive sound noise reduction processing section 252 acquires the frequency spectrum S13 which is closest to the frequency spectra S11 and S12 in the future direction on the time axis, as the second frequency spectrum corresponding to the frequency spectra S11 and S12 which are the first frequency spectra on the basis of the operation timing signal indicating the impulsive sound generation period t20 to t21 corresponding to the operation-stop-timing t20.

Moreover, the impulsive sound noise reduction processing section 252 replaces at least a part of the first frequency spectra with a corresponding portion of the second frequency spectra.

For example, the impulsive sound noise reduction processing section 252 compares frequency spectra equal to or more than the predefined threshold value frequency among the first frequency spectra with frequency spectra equal to or more than the predefined threshold value frequency among the second frequency spectra, for each frequency component, and, if it is determined that the second frequency spectrum is smaller than the first frequency spectrum, the frequency components of the first frequency spectrum are replaced with the frequency components of the second frequency spectrum.

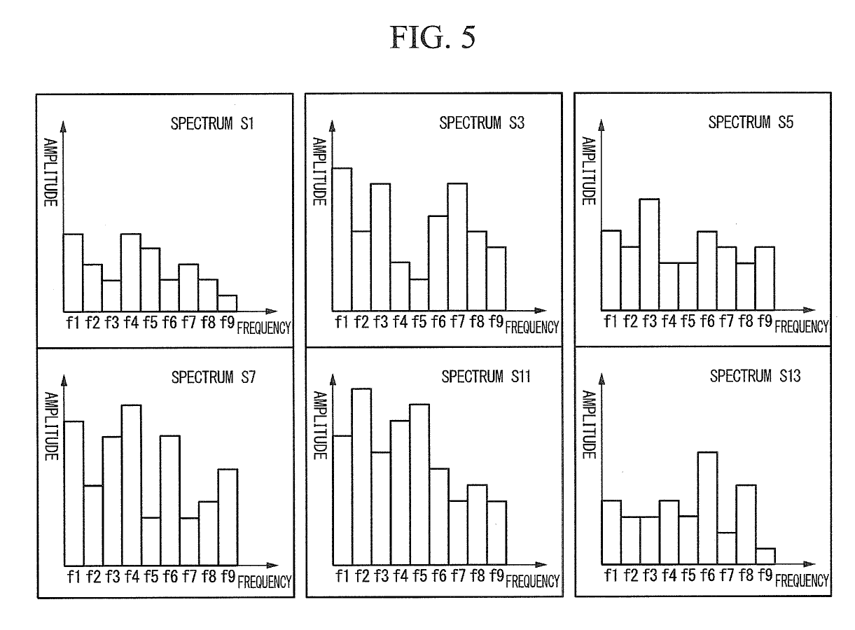

This will be described in detail with reference to FIG. 5. FIG. 5 is a diagram illustrating an example of the frequency components of a part of the frequency spectra. In addition, in the present embodiment, for convenience of description, of the microphone audio signal shown in FIG. 3, the frequency spectra S1, S3, S5, S7, S11 and S13 corresponding to the window functions W1, W3, W5, W7, W11 and W13 will be described.

As shown in FIG. 5, the frequency spectra S1, S3, S5, S7, S11 and S13 respectively include frequency components f1 to f9.

For example, it is predefined that the impulsive sound noise reduction processing section 252 compares the first frequency spectra with the second frequency spectra in relation to the frequency components f3 to f9 as frequency components equal to or more than the threshold value frequency for each frequency spectrum. Therefore, the impulsive sound noise reduction processing section 252 does not compare the first frequency spectra with the second frequency spectra in relation to the frequency components f1 and f2.

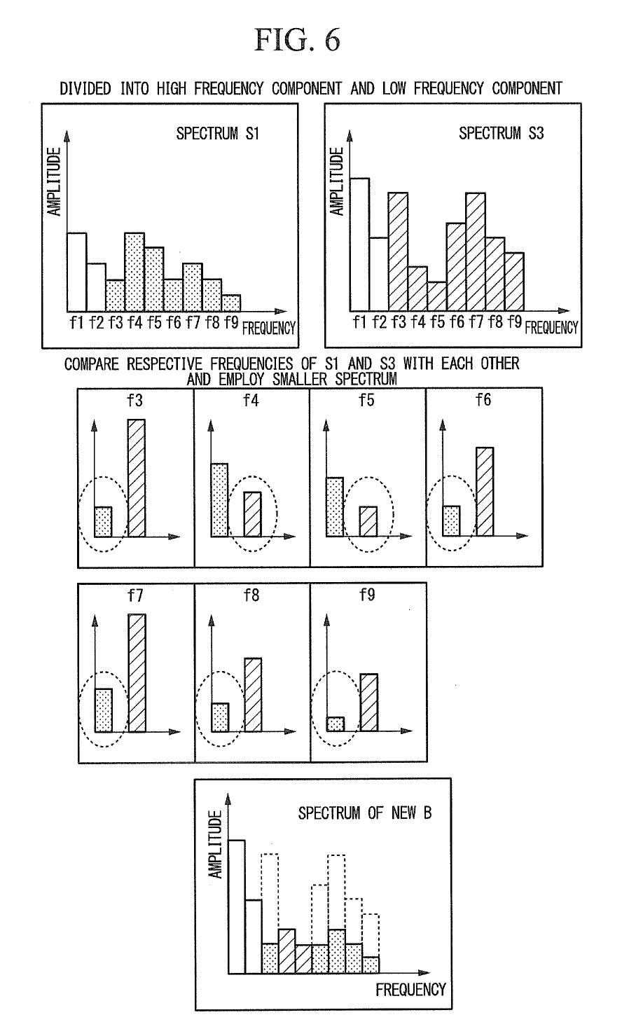

Here, with reference to FIG. 6, description will be made of an example of the impulsive sound noise reduction process performed by the impulsive sound noise reduction processing section 252 in relation to the frequency spectra S1 and S3.

FIG. 6 is a diagram illustrating a comparison of the amplitude for the respective frequency components of the frequency spectra S1 and S3.

For example, the impulsive sound noise reduction processing section 252 compares the amplitude of the frequency component f3 of the frequency spectrum S1 with the amplitude of the frequency component f3 of the frequency spectrum S3. In this case, the amplitude of the frequency component f3 of the frequency spectrum S1 is smaller than the amplitude of the frequency component f3 of the frequency spectrum S3. Therefore, the impulsive sound noise reduction processing section 252 replaces the frequency component f3 of the frequency spectrum S3 with the frequency component f3 of the frequency spectrum S1.

In addition, the impulsive sound noise reduction processing section 252 compares the amplitude of the frequency component f4 of the frequency spectrum S1 with the amplitude of the frequency component f4 of the frequency spectrum S3. In this case, the amplitude of the frequency component f4 of the frequency spectrum S1 is greater than the amplitude of the frequency component f4 of the frequency spectrum S3. Therefore, the impulsive sound noise reduction processing section 252 does not replace the frequency component f4 of the frequency spectrum S3 with the frequency component f4 of the frequency spectrum S1.

In this way, only in a case where the amplitude of the frequency component of the frequency spectrum S1 is smaller than the amplitude of the frequency component of the frequency spectrum S3, the impulsive sound noise reduction processing section 252 replaces the frequency component of the frequency spectrum S3 with the frequency component of the frequency spectrum S1.

In the case shown in FIG. 6, the impulsive sound noise reduction processing section 252 replaces the frequency components f3 and f6 to f9 of the frequency spectrum S3 with the frequency components f3 and f6 to f9 of the frequency spectrum S1.

Referring to FIG. 1 again, the description of each constituent element of the noise reduction processing unit 250 is continued.

The driving sound noise reduction processing section 253 acquires a frequency spectrum (hereinafter, referred to as a third frequency spectrum) corresponding to a time period when the driving sound is generated with high possibility from the frequency spectra S1 to S14 output from the audio signal processing section 251 on the basis of the operation timing signal input from the timing signal detection section 191. For example, the driving sound noise reduction processing section 253 acquires the frequency spectra S2 to S12 corresponding to a time period when the driving sound may possibly be generated as the third frequency spectra on the basis of the operation timing signal indicating the impulsive sound generation period t10 to t11 corresponding to the operation-start-timing t10 and the operation timing signal indicating the impulsive sound generation period t20 to t21 corresponding to the operation-stop-timing t20.

The driving sound noise reduction processing section 253 performs a driving sound noise reduction process for reducing noise which is predefined according to a driving pattern for the acquired third frequency spectrum. For example, the driving sound noise reduction processing section 253 uses a frequency spectrum subtraction method where a frequency component of a frequency spectrum indicating the noise which is predefined according to a driving pattern is subtracted from a frequency component of the third frequency spectrum. In addition, the frequency spectrum of the noise which is predefined according to a driving pattern is set in advance in the driving sound noise reduction processing section 253 as a set value. However, the present invention is not limited thereto, and the driving sound noise reduction processing section 253 may calculate an estimated frequency spectrum of noise of a driving sound for each driving pattern by subtracting a frequency spectrum of a section where the driving sound is not generated from a frequency spectrum of a section where the driving sound is generated on the basis of a microphone audio signal in the past.

The inverse Fourier transform section 254 performs, for example, the inverse Fourier transform or the inverse fast Fourier transform (IFFT) for the frequency spectrum input from the driving sound noise reduction processing section 253 so as to be converted into a time domain.

The inverse Fourier transform section 254 stores an audio signal converted into the time domain in the storage medium 200. In addition, the inverse Fourier transform section 254 may store the audio signal converted into the time domain and image data imaged by the imaging device 119 so as to be correlated with each other as the same kind having corresponding date information, or may store them as a moving image including the audio signal, in the storage medium 200.

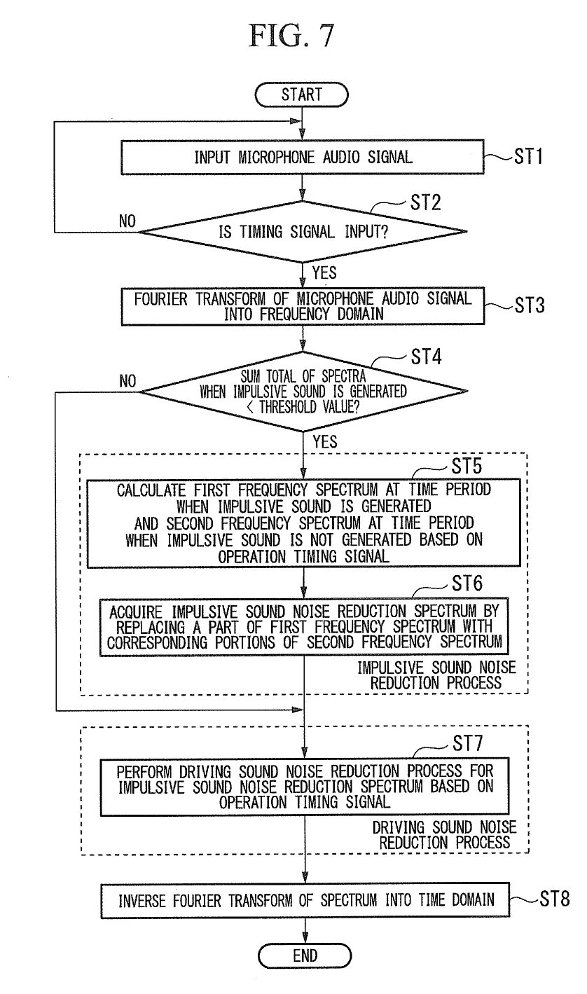

Next, with reference to FIG. 7, an example of the noise reduction processing method according to the present embodiment will be described. FIG. 7 is a flowchart illustrating an example of the noise reduction processing method according to the present embodiment.

For example, when the power switch of the manipulation unit 180 is turned on, the imaging apparatus 100 is powered on, and power is supplied to the respective constituent elements from the battery 260. In the present embodiment, it is preset in the imaging apparatus 100 that image data and audio date at the time of imaging are stored in the storage medium 200 so as to be correlated with each other.

(Step ST1)

For example, when power is supplied, the microphone 230 outputs a collected microphone audio signal to the A/D conversion unit 240. The A/D conversion unit 240 outputs the microphone audio signal which is a digital signal obtained by converting the microphone audio signal which is an analog signal to the noise reduction processing unit 250.

The noise reduction processing unit 250 receives the microphone audio signal from the A/D conversion unit 240.

Here, when a user presses the release button of the manipulation unit 180, in the AF process, the CPU 190 outputs a driving control signal for performing an AF process for adjusting focus at a focal length a to the lens driving section 116 and the timing signal detection section 191.

The lens driving section 116 moves the AF lens 112 according to a driving pattern for adjusting focus at a focal length a on the basis of the input driving control signal. For example, the lens driving section 116 rotates the driving mechanism of the AF lens 112 by a predetermined amount clockwise, thereby moving the AF lens 112. In addition, a rotation amount where the driving mechanism is rotated or a speed is predefined as the driving pattern for adjusting focus at a focal length α.

When the AF lens 112 is moved, the AF encoder 117 outputs a pulse signal to the timing signal detection section 191 of the CPU 190. When the moving AF lens 112 stops, the AF encoder 117 stops outputting the pulse signal.

The timing signal detection section 191 generates an operation timing signal according to the driving pattern for adjusting focus at a focal length a on the basis of the input driving control signal or the pulse signal from the AF encoder 117, and outputs the operation timing signal to the noise reduction processing unit 250.

For example, in a case of inputting the driving control signal for performing the AF process for adjusting focus at a focal length α, the timing signal detection section 191 generates an operation-start-timing signal indicating the impulsive sound generation period t10 to t11 corresponding to the operation-start-timing t10 of the AF lens 112 so as to be output to the noise reduction processing unit 250.

In addition, in a case where the pulse signal input from the AF encoder 117 is stopped, the timing signal detection section 191 generates an operation-stop-timing signal indicating the impulsive sound generation period t20 to t21 corresponding to the operation-stop-timing t20 of the AF lens 112 so as to be output to the noise reduction processing unit 250.

(Step ST2)

The noise reduction processing unit 250 determines whether or not the operation timing signal is input from the timing signal detection section 191.

(Step ST3)

If the operation timing signal is input, the audio signal processing section 251 of the noise reduction processing unit 250 weights the microphone audio signal output from the A/D conversion unit 240 for each predefined section with a window function and converts the microphone audio signal for each section into a frequency spectrum represented in the frequency domain. The audio signal processing section 251, for example, performs the Fourier transform for the audio signal weighted with the window function, thereby calculating the frequency spectra S1 to S14.

(Step ST4)

In addition, the audio signal processing section 251 compares the sum total of frequency components of the frequency spectra corresponding to the impulsive sound generation periods with a predefined threshold value.

For example, the audio signal processing section 251 acquires the frequency spectra S2 to S4 corresponding to the time period when the impulsive sound may possibly be generated on the basis of the operation timing signal indicating the impulsive sound generation period t10 to t11 corresponding to the operation-start-timing t10. In addition, the audio signal processing section 251 determines whether or not the sum total of the frequency components is smaller than the predefined threshold value for each of the frequency spectra S2 to S4. Further, the audio signal processing section 251 acquires the frequency spectra S9 to S12 corresponding to the time period when the impulsive sound may possibly be generated on the basis of the operation timing signal indicating the impulsive sound generation period t20 to t21 corresponding to the operation-stop-timing t20. In addition, the audio signal processing section 251 determines whether or not the sum total of the frequency components is smaller than the predefined threshold value for each of the frequency spectra S9 to S12.

The audio signal processing section 251 outputs the frequency spectra where the sum total of the frequency components is smaller than the predefined threshold value to the impulsive sound noise reduction processing section 252 and controls the impulsive sound noise reduction processing section 252 so as to perform an impulsive sound reduction process for the frequency spectra.

(Step ST5)

Next, the impulsive sound noise reduction processing section 252 performs the impulsive sound noise reduction process for the microphone audio signal input from the A/D conversion unit 240 on the basis of the control for performing the impulsive sound noise reduction process from the audio signal processing section 251.

For example, the impulsive sound noise reduction processing section 252 acquires the frequency spectra S2 to S4 corresponding to the time period when the impulsive sound may possibly be generated on the basis of the operation timing signal indicating the impulsive sound generation period t10 to t11 corresponding to the operation-start-timing t10, as the first frequency spectra.

In addition, the impulsive sound noise reduction processing section 252 acquires the frequency spectrum S1 which is located right before the frequency spectra S2 and S3, as the second frequency spectrum corresponding to the frequency spectra S2 and S3 which are the first frequency spectra on the basis of the operation timing signal indicating the impulsive sound generation period t10 to t11 corresponding to the operation-start-timing t10. In addition, the impulsive sound noise reduction processing section 252 acquires the frequency spectrum S5 which is located right after the frequency spectrum S4, as the second frequency spectrum corresponding to the frequency spectrum S4 which is the first frequency spectrum on the basis of the operation timing signal indicating the impulsive sound generation period t10 to t11 corresponding to the operation-start-timing t10.

In addition, the impulsive sound noise reduction processing section 252 acquires the frequency spectra S9 to S12 corresponding to the time period when the impulsive sound may possibly be generated on the basis of the operation timing signal indicating the impulsive sound generation period t20 to t21 corresponding to the operation-stop-timing t20, as the first frequency spectra.

Further, the impulsive sound noise reduction processing section 252 acquires the frequency spectrum S8 which is located right before the frequency spectra S9 and S10, as the second frequency spectrum corresponding to the frequency spectra S9 and S10 which are the first frequency spectra on the basis of the operation timing signal indicating the impulsive sound generation period t20 to t21 corresponding to the operation-stop-timing t20. In addition, the impulsive sound noise reduction processing section 252 acquires the frequency spectrum S13 which is located right after the frequency spectra S11 and S12, as the second frequency spectrum corresponding to the frequency spectra S11 and S12 which are the first frequency spectra on the basis of the operation timing signal indicating the impulsive sound generation period t20 to t21 corresponding to the operation-stop-timing t20.

(Step ST6)

Next, the impulsive sound noise reduction processing section 252 compares the first frequency spectra with the second frequency spectra in relation to the frequency components f3 to f9 as frequency components equal to or more than the threshold value frequency for each frequency spectrum.

For example, the impulsive sound noise reduction processing section 252 compares the amplitude of the frequency component f3 of the frequency spectrum S1 with the amplitude of the frequency component f3 of the frequency spectrum S2. In this case, the amplitude of the frequency component f3 of the frequency spectrum S1 is smaller than the amplitude of the frequency component f3 of the frequency spectrum S2. Therefore, the impulsive sound noise reduction processing section 252 replaces the frequency component f3 of the frequency spectrum S3 with the frequency component f3 of the frequency spectrum S1.

In addition, the impulsive sound noise reduction processing section 252 compares the amplitude of the frequency component f4 of the frequency spectrum S1 with the amplitude of the frequency component f4 of the frequency spectrum S2. In this case, the amplitude of the frequency component f4 of the frequency spectrum S1 is greater than the amplitude of the frequency component f4 of the frequency spectrum S2. Therefore, the impulsive sound noise reduction processing section 252 does not replace the frequency component f4 of the frequency spectrum S3 with the frequency component f4 of the frequency spectrum S1.

In this way, only in a case where the amplitude of the frequency component of the frequency spectrum S1 is smaller than the amplitude of the frequency component of the frequency spectrum S3, the impulsive sound noise reduction processing section 252 replaces the frequency component of the frequency spectrum S3 with the frequency component of the frequency spectrum S1.

The impulsive sound noise reduction processing section 252 replaces the frequency components f3 and f6 to f9 of the frequency spectrum S3 with the frequency components f3 and f6 to f9 of the frequency spectrum S1, and outputs a frequency spectrum S′3 having undergone the impulsive sound noise reduction process to the driving sound noise reduction processing section 253.

Similarly, the impulsive sound noise reduction processing section 252 compares the frequency spectrum S2 which is the first frequency spectrum with the frequency spectrum S1 which is the second frequency spectrum, and compares the frequency spectrum S4 which is the first frequency spectrum with the frequency spectrum S5 which is the second frequency spectrum. In addition, only in a case where the amplitudes of the frequency components of the second frequency spectra S1 and S5 are respectively smaller than the amplitudes of the frequency components of the frequency spectra S2 and S4, the frequency components of the frequency spectra S2 and S4 are replaced with the frequency components of the frequency spectra S1 and S5, and frequency spectra S′2 and S′4 having undergone the impulsive sound noise reduction process are output to the driving sound noise reduction processing section 253.

Similarly, the impulsive sound noise reduction processing section 252 compares the frequency spectra S9 and S10 which are the first frequency spectra with the frequency spectrum S8 which is the second frequency spectrum, and compares the frequency spectra S11 and S12 which are the first frequency spectra with the frequency spectrum S13 which is the second frequency spectrum. In addition, only in a case where the amplitudes of the frequency components of the second frequency spectrum S8 are respectively smaller than the amplitudes of the frequency components of the frequency spectra S9 and S10, the frequency components of the frequency spectra S9 and S10 are replaced with the frequency components of the frequency spectrum S8, and frequency spectra S′9 and S′10 having undergone the impulsive sound noise reduction process are output to the driving sound noise reduction processing section 253. Similarly, only in a case where the amplitudes of the frequency components of the second frequency spectrum S13 are respectively smaller than the amplitudes of the frequency components of the frequency spectra S11 and S12, the frequency components of the frequency spectra S11 and S12 are replaced with the frequency components of the frequency spectrum S13, and frequency spectra S′11 and S′12 having undergone the impulsive sound noise reduction process are output to the driving sound noise reduction processing section 253.

(Step ST7)

Next, the driving sound noise reduction processing section 253 performs a driving sound noise reduction process on the basis of the frequency spectra of the microphone audio signal input from the audio signal processing section 251 and the frequency spectra having undergone the impulsive sound noise reduction process input from the impulsive sound noise reduction processing section 252. For example, the driving sound noise reduction processing section 253 acquires the frequency spectra S2 to S12 corresponding to a time period when the driving sound may possibly be generated as the third frequency spectra on the basis of the operation timing signal indicating the impulsive sound generation period t10 to t11 corresponding to the operation-start-timing t10 and the operation timing signal indicating the impulsive sound generation period t20 to t21 corresponding to the operation-stop-timing t20.

The driving sound noise reduction processing section 253 replaces the frequency spectra S2 to S4 and S9 to S12 corresponding to the frequency spectra having undergone the impulsive sound noise reduction process among the acquired third frequency spectra S2 to S12 with frequency spectra S′2, S′3, S′4, S′9, S′10, S′11 and S′12. In addition, the driving sound noise reduction processing section 253 performs a driving sound noise reduction process for the frequency spectra S′2, S′3, S′4, S′9, S′10, S′11 and S′12 having undergone the impulsive sound noise reduction process and the frequency spectra S5 to S7. In other words, the driving sound noise reduction processing section 253 subtracts frequency components of frequency spectra indicating noise which is predefined according to a driving pattern from the frequency components of the third frequency spectra S′2 to S′4, S5 to S7 and S′9 to S′12 having undergone the impulsive sound noise reduction process. The driving sound noise reduction processing section 253 outputs the frequency spectra having undergone the driving sound noise reduction process to the inverse Fourier transform section 254.

(Step ST8)

The inverse Fourier transform section 254 performs, for example, the inverse Fourier transform for the frequency spectra having undergone the driving sound noise reduction process, input from the driving sound noise reduction processing section 253, so as to be converted into the time domain. The inverse Fourier transform section 254 stores an audio signal converted into the time domain in the storage medium 200.

As described above, the imaging apparatus 100 according to the present embodiment detects a timing when an operation state of the operation unit is varied using the operation timing signal detection section 191, and performs the impulsive sound noise reduction process where a part of the frequency spectra of the microphone audio signal having possibility that impulsive sounds may overlap each other with a part of the frequency spectra of the microphone audio signal having possibility that the impulsive sounds may not overlap each other. Thereby, it is possible to acquire an audio signal where discontinuity of a target sound is not visible and an impulsive sound is reduced even if the impulsive sound has a wideband frequency spectrum.

In addition, the imaging apparatus 100 according to the present embodiment preferably substitutes, as a part of the second frequency spectra of a microphone audio signal having high possibility that the impulsive sounds may not overlap each other, frequency spectra satisfying any one condition of the following (1) to (4) for a part of the first frequency spectra of the microphone audio signal having high possibility that the impulsive sounds may overlap each other.

(1) The second frequency spectrum which is based on an audio signal acquired during a time period having high possibility that an impulsive sound may not be generated, adjacent to or overlapping a time period having high possibility that the impulsive sound may be generated.

(2) The second frequency spectrum which is based on an audio signal acquired during a time period that an impulsive sound and a driving sound may not be generated.

(3) The second frequency spectrum having frequency components equal to or more than a predefined threshold value among the second frequency spectra.

(4) The second frequency spectrum having frequency components equal to or more than a predefined ratio in a sum total of frequency components of the frequency spectrum among the second frequency spectra.

In addition, in a case where the amplitudes of the frequency components of the first frequency spectrum are smaller than those of the frequency components of the second frequency spectrum, the impulsive sound noise reduction processing section 252 replaces the portion. In other words, the impulsive sound noise reduction processing section 252 (5) substitutes only the frequency components of the second frequency spectra smaller than the frequency components of the first frequency spectrum among the second frequency spectra satisfying the conditions (1) to (4).

As such, a portion of the first frequency spectra corresponding to second frequency spectra satisfying at least one of (1) to (4) is replaced, and thereby it is possible to acquire an audio signal where discontinuity of a target sound is not visible and an impulsive sound is reduced even if the impulsive sound has a wideband frequency spectrum.

The above-described condition (3) may be determined according to, for example, the kind of target sound.

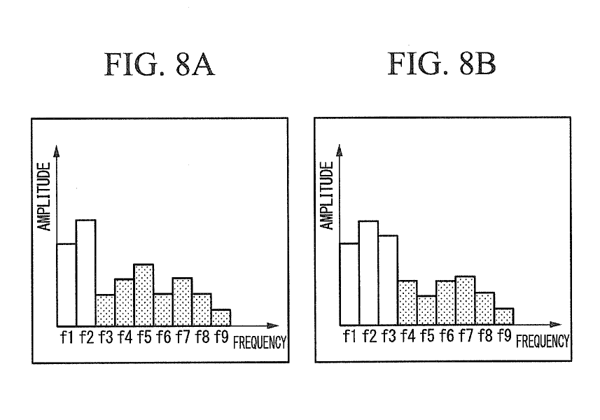

FIG. 8A is a diagram illustrating an example of the frequency spectrum in a case where a target sound is a male voice. And FIG. 8B is a diagram illustrating an example of the frequency spectrum in a case where a target sound is a female voice.

As shown in FIG. 8A, in a case where the target sound is a male voice, frequency components having a low frequency are more than those in a case where the target sound is a female voice, and are thus preferably set as a replacement range of the first frequency spectrum and the second frequency spectrum.

Here, in a case where the target sound is a male voice, the impulsive sound noise reduction processing section 252 does not perform replacement for the frequency components f1 and f2 and compares the magnitude of only the frequency components f3 to f9 with that of the frequency components of the first frequency spectrum. And in a case where the amplitudes of the frequency components of the second frequency spectrum are smaller than the amplitudes of the frequency components of the first frequency spectrum, the frequency components of the first frequency spectrum are replaced with the frequency components of the second frequency spectrum.

Similarly, in a case where the target sound is a female voice, the impulsive sound noise reduction processing section 252 does not perform replacement for the frequency components f1, f2 and f3 and compares the magnitude of only the frequency components f4 to f9 with that of the frequency components of the first frequency spectrum.

This is because a dominant spectrum is included in the frequency components having a low frequency in the male voice more than in the female voice. In addition, the dominant spectrum refers to a spectrum which more includes a frequency spectrum indicating features of the target sound. As such, since the dominant frequency spectrum is not replaced, it is possible to prevent deterioration in the target sound. Therefore, discontinuity of the target sound is not visible and an impulsive sound can be reduced.

The above-described condition (4) may be determined as, for example, 60% of frequency components having a high frequency with respect to, for example, a sum total of frequency components of a frequency spectrum.

In this case, the impulsive sound noise reduction processing section 252 considers all the sums of frequency components of the first frequency spectrum as 100%, and does not compare 40% of frequency components (f1, f2, . . . ) having a low frequency with those of the second frequency spectrum. The impulsive sound noise reduction processing section 252 compares 60% of frequency components (f9, f8, . . . ) having a high frequency with those of the second frequency spectrum.

Thereby, it is possible to prevent deterioration in a target sound for the frequency components having a low frequency in the frequency spectrum.

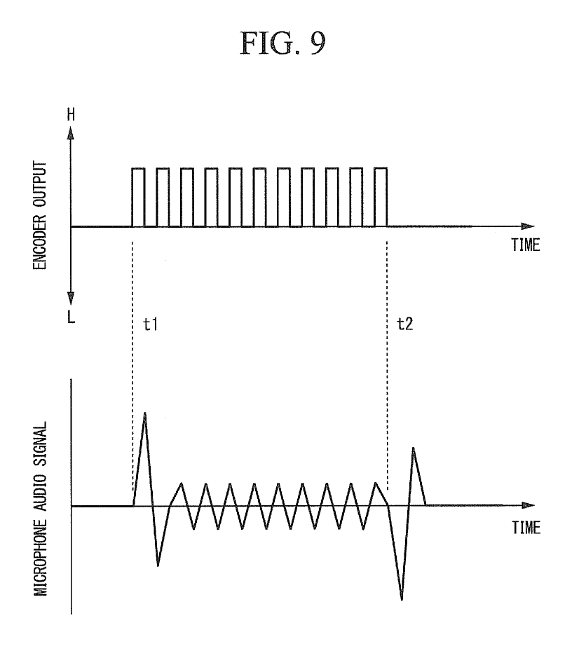

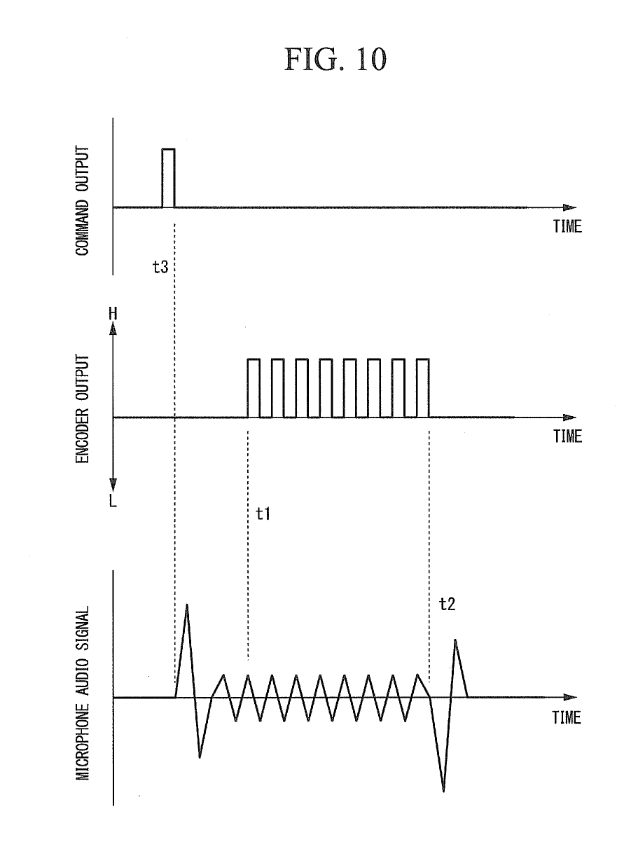

Next, an example of the operation-start-timing detected by the timing signal detection section 191 will be described with reference to FIGS. 9 and 10.

FIG. 9 is a diagram illustrating an example of the output of the AF encoder 117 and the microphone audio signal output by the microphone 230.

As shown in FIG. 9, a description will be made of an example of the case where a time period when the output of the AF encoder 117 repeats a high level and a low level is determined as a time period when an operation sound is generated by the operation unit.

In this case, a time point when the output of the AF encoder 117 initially becomes a high level is an operation-start-timing t1. Therefore, a time period when an impulsive sound is generated is started from the time point t1. In addition, a time point when the output of the AF encoder 117 finally becomes a high level and then returns to a low level is an operation-stop-timing t2. Therefore, a time period when the impulsive sound is generated is started from the time point t2.

However, in this case, there are cases where the output of the AF encoder 117 may be deviated from an actual operation-start-timing of a driving system of the AF lens 112 due to influence of backlash of the driving system (gear train or the like) of the AF lens 112. This case will be described with reference to FIG. 10. FIG. 10 is a diagram illustrating another example of the output of the AF encoder 117 and the microphone audio signal output by the microphone 230.

As shown in FIG. 10, an actual operation-start-timing of the driving system of the AF lens 112 is generated earlier (past) than the time period when the output of the AF encoder 117 repeats a high level and a low level in the time axis direction. In this case, the operation-start-timing is a time point t3, and the impulsive sound is generated within a certain time period from the time point t3.

Therefore, when the time point t1 is an operation-start-timing, the impulsive sound noise reduction processing section 252 treats the certain time period from the time point t1 as a time period having high possibility that the impulsive sound may be generated. In this case, there is high possibility that the impulsive sound may not be included in the first frequency spectrum acquired by the impulsive sound noise reduction processing section 252.

Therefore, the timing signal detection section 191, as described with reference to FIG. 10, generates an operation-start-timing signal indicating a time point when a driving control signal (command) is output to the operation unit as the operation-start-timing, in order to prevent a disadvantage that the actual start timing of the driving is deviated from the output of the AF encoder 117.

### Modified Examples

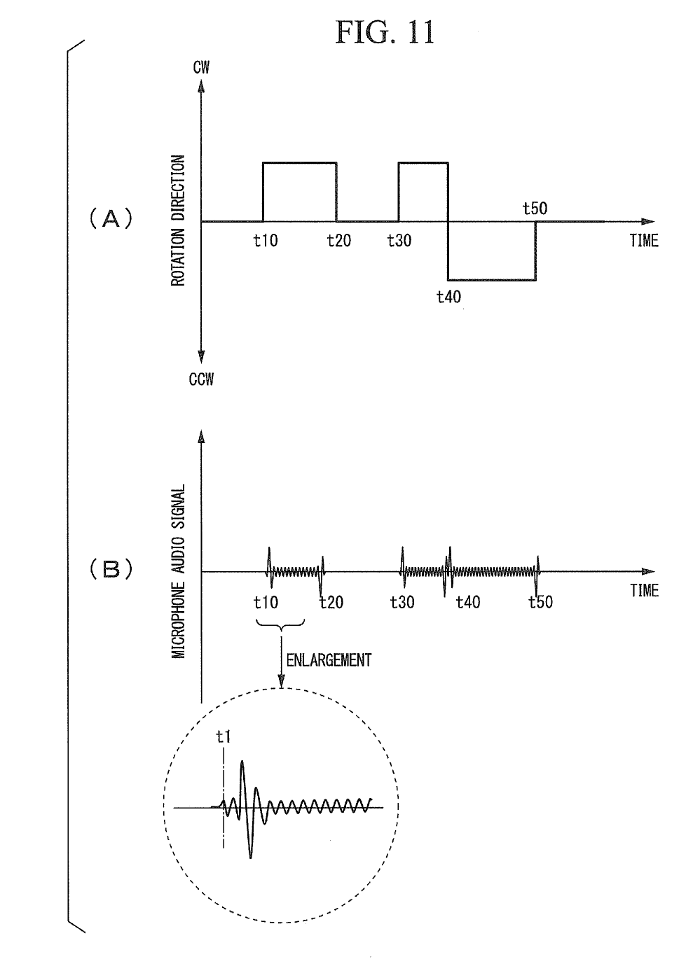

Next, with reference to FIGS. 11 to 13, another example of the driving pattern of the imaging apparatus 100 according to the present embodiment will be described.

FIG. 11(A) shows an example of the relationship between a rotation direction obtained from the output of the AF encoder 117 and time. FIG. 11(B) shows an example of the relationship between a microphone audio signal and time. In addition, for convenience of description, FIG. 11(B) shows only an audio signal of the operation sound of the microphone audio signal and does not show an audio signal of the target sound. The driving pattern of the AF lens 112 shown in FIGS. 11(A) and 11(B) indicates, for example, a driving pattern in a case where an AF process for adjusting focus at a focal length β is performed.

In FIG. 11(A), the longitudinal axis expresses a rotation direction of the driving mechanism driving the AF lens 112, as an output of the AF encoder 117.

In the driving pattern where an AF process for adjusting focus at a focal length β is performed, as shown in FIG. 11(A), the driving mechanism driving the AF lens 112 is rotated clockwise CW during the time points t10 to t20 and then is stopped. In addition, the driving mechanism driving the AF lens 112 is rotated clockwise CW again up to the time points t30 to t40, thereafter, reverses its rotation direction, is rotated counterclockwise CCW up to the time points t40 to t50, and is then stopped.

In other words, the time points t10 and t30 respectively indicate operation-start-timings of the AF lens 112, and the time points t20 and t50 respectively indicate operation-stop-timings of the AF lens 112. In addition, the time point t40 indicates a timing when a driving direction of the AF lens 112 is reversed.

Therefore, as shown in FIG. 11(B), during the time period of the time points t10 to t20 and the time period of the time points t30 to t50, an operation sound due to the AF lens 112 is superposed on the microphone audio signal or the operation sound may be superposed thereon with high possibility. In the present embodiment, a case where noise which is an operation sound due to the AF lens 112 is generated during the time period of the time points t10 to t20 and the time period of the time points t30 to t50 will be described below.

In addition, as shown in FIG. 11(B), there is high possibility that impulsive sounds may be generated at the time points t10, t20, t30, t40 and t50, respectively. In the present embodiment, a case where the impulsive sounds are generated by the AF lens 112 at the time points t10, t20, t30, t40 and t50 will be described below.

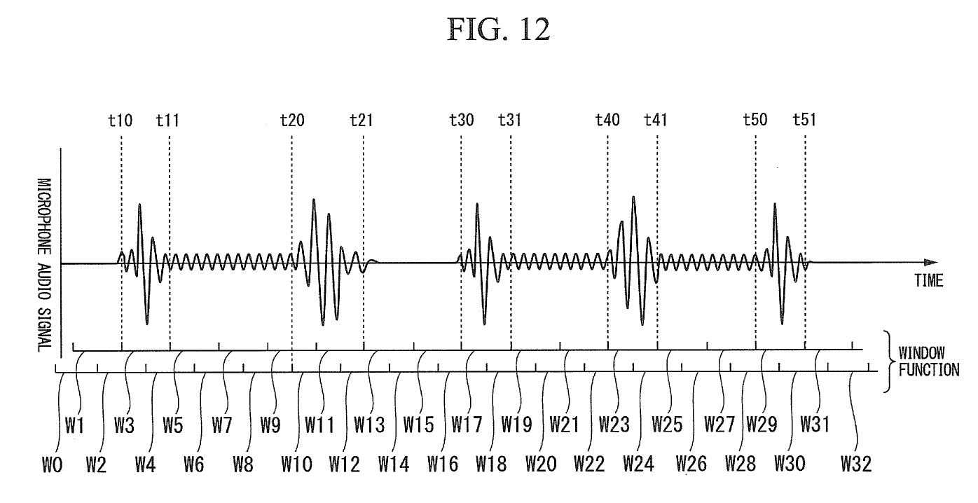

In addition, in a case where an impulsive sound is generated, time when the impulsive sound is generated with high possibility is predefined according to each driving pattern. In the driving pattern where an AF process for adjusting focus at a focal length β is performed, time when the impulsive sound is generated as shown in FIG. 12 is defined.

FIG. 12 shows an example of the microphone audio signal collected by the microphone 230 when the AF lens 112 is driven by the driving pattern where an AF process for adjusting focus at a focal length β is performed. In addition, for convenience of description, FIG. 12 shows only an audio signal of the operation sound of the microphone audio signal and does not show an audio signal of the target sound.

In the driving pattern where an AF process for adjusting focus at a focal length β is performed, the time of the time points t10 to t11, the time of the time points t20 to t21, the time of the time points t30 to t31, the time of the time points t40 to t41, and time of the time points t50 to t51 are respectively predefined as the time when the impulsive sound is generated.

In the present embodiment, as shown in FIG. 12, an example where the impulsive sound is generated during the time periods when the impulsive sound is generated will be described.

The audio signal processing section 251 weights the microphone audio signal output from the A/D conversion unit 240 with the window functions W0 to W32 which overlap other sections by a half as shown in FIG. 12. Thereby, the microphone audio signal is divided into the sizes of the window functions. The audio signal processing section 251 performs, for example, the Fourier transform for the microphone audio signal of each section weighted with the window functions W0 to W32, and calculates frequency spectra S0 to S32 in the frequency domain.

In the present embodiment, the frequency spectra S2 to S4 corresponding to the window functions W2 to W4 are audio information including the impulsive sound generation period t10 to t11 corresponding to the operation-start-timing t10 of the AF lens 112. In addition, the frequency spectra S9 to S12 corresponding to the window functions W9 to W12 are audio information including the impulsive sound generation period t20 to t21 corresponding to the operation-stop-timing t20 of the AF lens 112. Further, the frequency spectra S16 to S18 corresponding to the window functions W16 to W18 are audio information including the impulsive sound generation period t30 to t31 corresponding to the operation-start-timing t30 of the AF lens 112. In addition, the frequency spectra S22 to S24 corresponding to the window functions W22 to W24 are audio information including the impulsive sound generation period t40 to t41 corresponding to the operation-reverse-timing t40 of the AF lens 112. More, the frequency spectra S28 to S30 corresponding to the window functions W28 to W30 are audio information including the impulsive sound generation period t50 to t51 corresponding to the operation-stop-timing t50 of the AF lens 112.

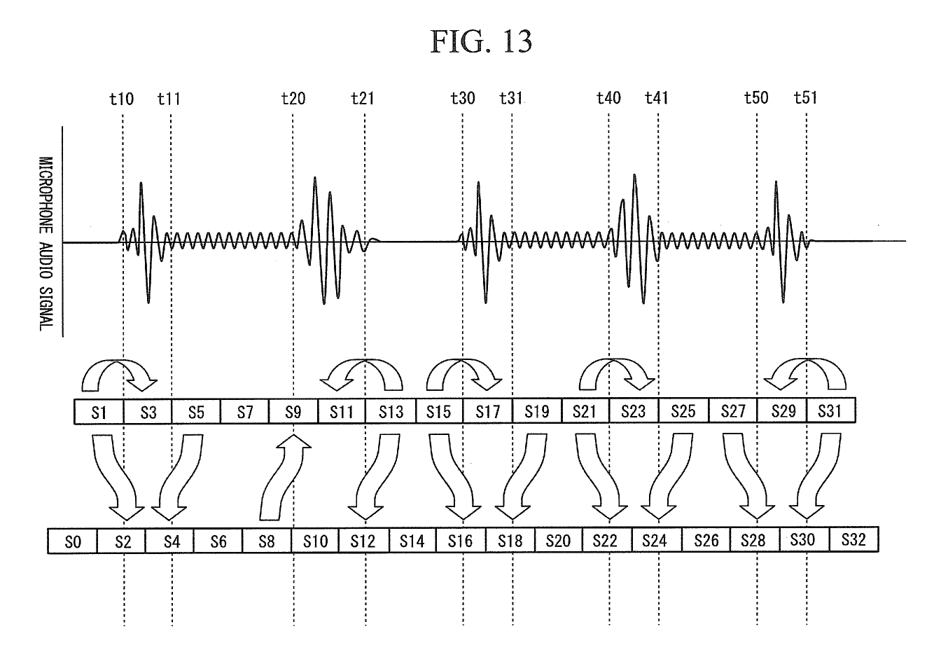

Here, with reference to FIG. 13, a description will be made of an example of the relationship between the first frequency spectra and the second frequency spectra acquired by the impulsive sound noise reduction processing section 252. FIG. 13 is a diagram illustrating an example of the relationship between the first frequency spectra and the second frequency spectra acquired by the impulsive sound noise reduction processing section 252.

The impulsive sound noise reduction processing section 252 acquires the frequency spectra S2 to S4 corresponding to the time period when the impulsive sound may possibly be generated on the basis of the operation timing signal indicating the impulsive sound generation period t10 to t11 corresponding to the operation-start-timing t10, for example, from the frequency spectra S0 to S32 output from the audio signal processing section 251, in response to an operation timing signal input from the timing signal detection section 191, as the first frequency spectra. In addition, the impulsive sound noise reduction processing section 252 acquires the frequency spectra S9 to S12 corresponding to the time period when the impulsive sound may possibly be generated on the basis of the operation timing signal indicating the impulsive sound generation period t20 to t21 corresponding to the operation-stop-timing t20, as the first frequency spectra. Moreover, the impulsive sound noise reduction processing section 252 acquires the frequency spectra S16 to S18 corresponding to the time period when the impulsive sound may possibly be generated on the basis of the operation timing signal indicating the impulsive sound generation period t30 to t31 corresponding to the operation-start-timing t30, as the first frequency spectra. In addition, the impulsive sound noise reduction processing section 252 acquires the frequency spectra S22 to S24 corresponding to the time period when the impulsive sound may possibly be generated on the basis of the operation timing signal indicating the impulsive sound generation period t40 to t41 corresponding to the operation-reverse-timing t40, as the first frequency spectra. Further, the impulsive sound noise reduction processing section 252 acquires the frequency spectra S28 to S30 corresponding to the time period when the impulsive sound may possibly be generated on the basis of the operation timing signal indicating the impulsive sound generation period t50 to t51 corresponding to the operation-stop-timing t50, as the first frequency spectra.

In addition, the impulsive sound noise reduction processing section 252 acquires the frequency spectrum S0 which is located right before the frequency spectrum S2, as the second frequency spectrum corresponding to the frequency spectrum S2 which is the first frequency spectrum on the basis of the operation timing signal indicating the impulsive sound generation period t10 to t11 corresponding to the operation-start-timing t10. Further, the impulsive sound noise reduction processing section 252 acquires the frequency spectrum S1 which is located right before the frequency spectrum S3, as the second frequency spectrum corresponding to the frequency spectrum S3 which is the first frequency spectrum on the basis of the operation timing signal indicating the impulsive sound generation period t10 to t11 corresponding to the operation-start-timing t10. In addition, the impulsive sound noise reduction processing section 252 acquires the frequency spectrum S5 which is located right after the frequency spectrum S4, as the second frequency spectrum corresponding to the frequency spectrum S4 which is the first frequency spectrum on the basis of the operation timing signal indicating the impulsive sound generation period t10 to t11 corresponding to the operation-start-timing t10.

Further, the impulsive sound noise reduction processing section 252 acquires the frequency spectrum S8 which is located right before the frequency spectrum S9 as the second frequency spectrum corresponding to the frequency spectrum S9 which is the first frequency spectrum, and acquires the frequency spectrum S8 which is located right before the frequency spectrum S10 as the second frequency spectrum corresponding to the frequency spectrum S10 which is the first frequency spectrum, on the basis of the operation timing signal indicating the impulsive sound generation period t20 to t21 corresponding to the operation-stop-timing t20.

Moreover, the impulsive sound noise reduction processing section 252 acquires the frequency spectrum S13 which is located right after the frequency spectrum S11 as the second frequency spectrum corresponding to the frequency spectrum S11 which is the first frequency spectrum, and acquires the frequency spectrum S13 which is located right after the frequency spectrum S12 as the second frequency spectrum corresponding to the frequency spectrum S12 which is the first frequency spectrum, on the basis of the operation timing signal indicating the impulsive sound generation period t20 to t21 corresponding to the operation-stop-timing t20.

In addition, the impulsive sound noise reduction processing section 252 acquires the frequency spectrum S15 which is located right before the frequency spectrum S17, as the second frequency spectrum corresponding to the frequency spectrum S17 which is the first frequency spectrum on the basis of the operation timing signal indicating the impulsive sound generation period t30 to t31 corresponding to the operation-start-timing t30.

Moreover, the impulsive sound noise reduction processing section 252 acquires the frequency spectrum S15 which is located right before the frequency spectrum S16 as the second frequency spectrum corresponding to the frequency spectrum S16 which is the first frequency spectrum, and acquires the frequency spectrum S19 which is located right after the frequency spectrum S18 as the second frequency spectrum corresponding to the frequency spectrum S18 which is the first frequency spectrum, on the basis of the operation timing signal indicating the impulsive sound generation period t30 to t31 corresponding to the operation-start-timing t30.

In addition, the impulsive sound noise reduction processing section 252 acquires the frequency spectrum S21 which is located right before the frequency spectrum S23, as the second frequency spectrum corresponding to the frequency spectrum S23 which is the first frequency spectrum on the basis of the operation timing signal indicating the impulsive sound generation period t40 to t41 corresponding to the operation-reverse-timing t40.

Further, the impulsive sound noise reduction processing section 252 acquires the frequency spectrum S21 which is located right before the frequency spectrum S22 as the second frequency spectrum corresponding to the frequency spectrum S22 which is the first frequency spectrum, and acquires the frequency spectrum S25 which is located right after the frequency spectrum S24 as the second frequency spectrum corresponding to the frequency spectrum S24 which is the first frequency spectrum, on the basis of the operation timing signal indicating the impulsive sound generation period t40 to t41 corresponding to the operation-reverse-timing t40.

In addition, the impulsive sound noise reduction processing section 252 acquires the frequency spectrum S31 which is located right after the frequency spectrum S29, as the second frequency spectrum corresponding to the frequency spectrum S29 which is the first frequency spectrum on the basis of the operation timing signal indicating the impulsive sound generation period t50 to t51 corresponding to the operation-stop-timing t50.

Further, the impulsive sound noise reduction processing section 252 acquires the frequency spectrum S27 which is located right before the frequency spectrum S28 as the second frequency spectrum corresponding to the frequency spectrum S28 which is the first frequency spectrum, and acquires the frequency spectrum S31 which is located right after the frequency spectrum S30 as the second frequency spectrum corresponding to the frequency spectrum S30 which is the first frequency spectrum, on the basis of the operation timing signal indicating the impulsive sound generation period t50 to t51 corresponding to the operation-stop-timing t50.

Moreover, the impulsive sound noise reduction processing section 252 replaces at least a part of the first frequency spectra with a corresponding portion of the second frequency spectra.

For example, the impulsive sound noise reduction processing section 252 compares frequency spectra equal to or more than the predefined threshold value frequency among the first frequency spectra with frequency spectra equal to or more than the predefined threshold value frequency among the second frequency spectra, for each frequency component, and, if it is determined that the second frequency spectrum is smaller than the first frequency spectrum, the frequency components of the first frequency spectrum is replaced with the frequency components of the second frequency spectrum.

In this way, the impulsive sound noise reduction processing section 252 performs the impulsive sound noise reduction process for the second frequency spectra adjacent to the first frequency spectra in the time axis direction.

In this case, in a case where, among the frequency spectra adjacent to the first frequency spectra in the time axis direction, frequency spectra which do not include the driving sound are adjacent thereto, the impulsive sound noise reduction processing section 252 performs comparison with the frequency spectra which do not include the driving sound. In addition, in a case where the frequency spectra adjacent in the time axis direction are frequency spectra including the driving sound and frequency spectra including the impulsive sound, the impulsive sound noise reduction processing section 252 acquires the frequency spectra including the driving sound as the second frequency spectra.

In addition, in a case where, as in the impulsive sound generation period t40 to t41 corresponding to the operation-reverse-timing t40, frequency spectra adjacent to the first frequency spectra in the time axis direction are entirely frequency spectra including the driving sound, the impulsive sound noise reduction processing section 252 acquires any one of the frequency spectra as the second frequency spectra. In this case, the impulsive sound noise reduction processing section 252 acquires a frequency spectrum closer to the first frequency spectra in the time axis direction, as the second frequency spectrum.

In addition, an execution process may be performed by recording a program which causes the timing signal detection section 191, the noise reduction processing unit 250, or the like to realize procedures on a computer readable recording medium, and by a computer system reading the program recorded on the recording medium so as to be executed. The “computer system” described here may include an OS (Operating System) or hardware such as peripheral devices.

In addition, in a case of using a WWW system, the “computer system” may include home page providing circumstances (or display circumstances). Further, the “computer readable recording medium” refers to a flexible disc, a magneto-optical disc, a ROM, a writable nonvolatile memory such as a flash memory, a portable medium such as a CD-ROM, a storage device such as a hard disk built into the computer system, or the like.

Further, the “computer readable recording medium” may include a medium which maintains a program for a certain time, such as a volatile memory (for example, a DRAM (Dynamic Random Access Memory)) of the computer system which becomes a server or a client when the program is transmitted via a network such as the Internet or a communication line such as a telephone line.

In addition, the program may be transmitted to other computer systems from the computer system storing the program in a storage device or the like, via a transmission medium, or by a transmitted wave in the transmission medium. Here, the “transmission medium” transmitting the program refers to a medium having a function transmitting information such as a network (communication network) such as the Internet or a communication line such as a telephone line.

The program may be a program for realizing a part of the above-described functions.

In addition, the program may be a so-called difference file (difference program) which can be realized through a combination with a program which has already been recorded in the computer system.

1. A noise reduction processing apparatus comprising:
a timing signal detection unit that detects an operation timing signal indicating a timing when an operation unit is operated;
an audio signal acquisition unit that acquires an audio signal; and
on the basis of the operation timing signal, a noise reduction processing unit that calculates first frequency spectra of an audio signal acquired during a time period which has high possibility that noise caused by an operation of the operation unit is generated and second frequency spectra of an audio signal acquired during a time period which has high possibility that the noise is not generated, and calculates a noise reduction audio signal obtained by performing noise reduction to the audio signal on the basis of frequency spectra in which at least a part of the calculated first frequency spectra are replaced with corresponding portions of the calculated second frequency spectra.

2. The noise reduction processing apparatus according to claim 1, wherein the noise reduction processing unit calculates the second frequency spectra on the basis of an audio signal acquired during a time period which has high possibility that the noise is not generated, and which is closest to a time period in which the noise is generated within a time axis direction.

3. The noise reduction processing apparatus according to claim 1, wherein the noise reduction processing unit calculates the second frequency spectra on the basis of an audio signal acquired during a time period which has high possibility that the noise of an impulsive sound, which is generated due to a variation of a state of the operation unit when the operation unit is operated, is not generated.

4. The noise reduction processing apparatus according to claim 1, wherein the noise reduction processing unit replaces frequency components of the first frequency spectra, included in a range of predefined frequency components of the audio signal acquired during the time period which has high possibility that the noise is generated, with frequency components of the second frequency spectra included in the range of the predefined frequency components.

5. The noise reduction processing apparatus according to claim 1, wherein, when the noise reduction processing unit compares amplitudes of the first frequency spectra with amplitudes of the second frequency spectra for each frequency component and determines that amplitudes of frequency components of the second frequency spectra are smaller than the frequency components of the first frequency spectra, the noise reduction processing unit replaces the frequency components of the first frequency spectra with the frequency components of the second frequency spectra.

6. The noise reduction processing apparatus according to claim 1, wherein, when the noise reduction processing unit determines whether or not a sum total of a plurality of frequency components which forms the second frequency spectra is equal to or more than a predefined threshold value and the sum total is smaller than the threshold value, the noise reduction processing unit replaces at least a part of the first frequency spectra with corresponding portions of the second frequency spectra.

7. The noise reduction processing apparatus according to claim 1, further comprising:
a control unit that outputs a command for driving the operation unit to a driving unit; and
an operation detection unit that detects a movement of the operation unit, and outputs an operation detection signal indicating that the operation unit on operation,
wherein the noise reduction processing unit determines a time period which has high possibility that the noise is generated on the basis of a first operation timing signal indicating a timing when the control unit output a command and a second operation timing signal indicating a timing that the operation detection unit stopped an output of the operation detection signal.

8. The noise reduction processing apparatus according to claim 1, wherein, when it is determined that it is a beginning of an operation of the operation unit on the basis of the operation timing signal, the noise reduction processing unit calculates the second frequency spectra on the basis of an audio signal acquired during a time period, which has high possibility that the noise is not generated, located right before a time period which has high possibility that the noise is generated at a beginning of an operation, and
wherein, when it is determined that it is an end of an operation of the operation unit on the basis of the operation timing signal, the noise reduction processing unit calculates the second frequency spectra on the basis of an audio signal acquired during a time period, which has high possibility that the noise is not generated, located right after a time period which has high possibility that the noise is generated at an ending of an operation.

9. An imaging apparatus comprising the noise reduction processing apparatus according to claim 1.

10. A noise reduction processing program causing a computer to function as:
a timing signal detection unit for detecting an operation timing signal indicating a timing when an operation unit is operated;
an audio signal acquisition unit for acquiring an audio signal; and
a noise reduction processing unit for calculating first frequency spectra of an audio signal acquired during a time period which has high possibility that noise caused by an operation of the operation unit is generated and second frequency spectra of an audio signal acquired during a time period which has high possibility that the noise is not generated, and calculating a noise reduction audio signal obtained by performing noise reduction to the audio signal on the basis of frequency spectra in which at least a part of the calculated first frequency spectra is replaced with corresponding portions of the calculated second frequency spectra.
